(19) United States
(12) Patent Application Publication
(10) Pub. No.: US 2013/0052028 A1
(43) Pub. Date: Feb. 28, 2013

(54) TURBINE ASSEMBLIES

(71) Applicant: Alexei I. Winter, Bristol (GB)

(72) Inventor: Alexei I. Winter, Bristol (GB)

(73) Assignee: TIDAL GENERATION LIMITED, Bristol (GB)

(21) Appl. No.: 13/519,054

(22) PCT Filed: Dec. 20, 2010
(86) PCT No.: PCT/GB2010/052156

§ 371 Date: Nov. 2, 2012

(30) Foreign Application Priority Data
Dec. 24, 2009 (GB) 0922615.0

(51) Int. Cl. F03B 3/12

(52) U.S. Cl. 416/223 R

(57) ABSTRACT

A turbine assembly comprising a plurality of turbine blades, each blade having a setting angle distribution such that the thrust coefficient of the blade increases with rotational speed of the turbine assembly up to a first rotational speed and decreases significantly beyond the first rotational speed up to a runaway speed for the turbine assembly.

The present invention relates to turbine assemblies and more particularly, although not exclusively, to turbine assemblies for use in hydrokinetic applications such as tidal power generation.

### BACKGROUND OF THE INVENTION

Conventional approaches to turbine blade design focus on producing blades with the highest possible efficiency. The ultimate purpose of the blade design is to capture the highest possible amount of energy from the free stream fluid.

A combination of actuator disc and blade element momentum theories results in two widely adopted equations in blade design that specify the chord and twist profiles of the blades as functions of the radius when various input parameters are specified. These two equations are given below:

$$c = \frac{\frac{16}{9} π R}{{C}_{L} N λ \sqrt{{( 1 - \frac{1}{3 f} )}^{2} + {λ}^{2} {{μ}^{2} [ 1 + \frac{( 1 - \frac{1}{3 f} )}{3 {λ}^{2} {μ}^{2} f} ]}^{2}}}$$

$$tan φ = \frac{1 - \frac{1}{3 f}}{λμ ( 1 + \frac{( 1 - \frac{1}{f 3} )}{3 {λ}^{2} {μ}^{2} f} )}$$

With variables defined as follows:
c=chord
phi=twist angle (defined as the angle between the blade section chord line and the rotor plane)
R=rotor radius
mu=non-dimensional local radius (defined as r/R, where r=local radius)
C_{L}=operating section lift coefficient
N=number of blades (usually 2 or 3)
Lambda=tip speed ratio (defined as the ratio of the speed of the blade tip to the speed of the free stream fluid)
f=tip/root loss factor (a correction to the equations to take account of loss of local lift due to the shedding of bound circulation)

Due to the way the equations are derived, blades designed to this pattern give the highest possible C_{P} (power coefficient) and can therefore be described as having the highest possible efficiency of energy capture.

An example blade geometry (non-dimensionalised against radius) generated using the conventional equations is shown in FIGS. 1a and 1b. The performance of the blade is described in the graph of FIG. 2 which plots power, torque and thrust coefficients against tip speed ratio.

Blades which are designed with the goal of maximising power coefficient above all else may exhibit undesirable behavioural characteristics in other areas. For example, it can be seen from the coefficient plot for the example blade of FIG. 1 that the thrust increases significantly as the rotor speed (tip speed ratio) increases. A significant challenge exists in the structural design of marine turbines in particular since the thrust for a marine turbine is around 4.5 times that of wind turbine with the equivalent power output due to the difference in density of the working fluids.

Furthermore turbine rotors do not operate in isolation, but as a component in a complex generating system. Other components place constraints on the performance of the rotor that must not be exceeded. For example, it is quite possible to design a rotor that produces a maximum torque which exceeds the operational limits of the associated gearbox or else a turbine rotor which produces a thrust so high that it threatens the integrity of the system.

As a result of the high thrust generated at higher tip speed ratios, turbines must be prevented from approaching the ‘runaway’ state. This is the rotor speed at which the net torque produced is zero and the rotor is spinning freely. Accordingly the runaway speed of a water turbine may be considered to be its speed under the conditions of full flow and no shaft load. For power generation applications, this state could potentially be achieved if the generator torque was suddenly removed (i.e. if grid connection was lost) or else if the gearbox failed such that resistance to the rotation of the turbine would be minimised.

It is generally known to provide control systems which are programmed to prevent such a runaway state. Conventional systems of this type typically involve the use of actuators in the rotor hub that alter the pitch of the blades in order to limit the torque generated. A shaft braking mechanism may also be engaged to decelerated or maintain a constant shaft speed if the rotor is in danger of exceeding threshold rotational speeds.

Preventing overspeeding is a particular problem for marine turbines. Due to the fluid density and speed differences, torques on a marine turbine will be around twice as high per unit of output power than for a wind turbine. Exacerbating this problem is the fact that rotor inertia is far lower than for wind turbines because marine turbines are typically smaller in size.

The result of this high torque, low inertia situation is that marine turbines react far faster to fluctuations in flow speed than wind turbines. The mass flow rates associated with, for example, tidal flow can create conditions in which a deviation in flow pattern, such as a significant turbulent eddy, could potentially cause significant overspeed in less than a second. Designing control and pitch systems than can react fast enough to moderate these relatively high frequency fluctuations is problematic and can result in expensive, heavy and complicated systems being installed within the turbine.

Furthermore, damage which can be caused by overspeed is expensive and time consuming to repair due to the need to raise the turbine to the surface of a body of water.

One previously-considered solution to these problems is described in UK Patent Application GB2461265, in which a turbine blade geometry is described which serves to reduce thrust at higher rotational speeds. The proposed design provides a blade in which the stagger angle (also known as the angle of attack or pitch) is chosen so that the thrust characteristics of the blade are within desired limits. However, such a design has inherent compromises since the stagger angle changes with flow speed, and so over a range of flow speeds, the stagger angle must always meet the design criterion. Such restrictions mean that the power coefficient of the blade is compromised compared with the ideal case.

It is an aim of the present invention to provide a turbine blade, a turbine and associated methods of design and operation which allow control of the rotational speed of a hydrokinetic turbine in a manner which mitigates at least some of the above problems.

### SUMMARY OF THE INVENTION

According to one aspect of the present invention there is provided a turbine assembly comprising a plurality of turbine blades, each blade having a setting angle distribution along the length of the blade such that the thrust coefficient of the blade increases with rotational speed of the turbine assembly up to a first rotational speed and decreases significantly beyond the first rotational speed up to a runaway speed for the turbine assembly.

The first speed may be that at which the turbine assembly achieves a maximum power condition.

The tip speed ratio (TSR) for a turbine or blade may be considered to be the ratio of the instantaneous linear speed of the tip of the blade to the velocity of the fluid approaching the turbine.

The first value of thrust coefficient of the blade at the first rotational speed of the turbine assembly may be that at which a maximum power coefficient of the turbine is achieved. A second value of thrust coefficient at the runaway speed for the turbine assembly is significantly lower than said first value.

In one example, the thrust coefficient decreases by 20% or more between the first rotational speed and the runaway speed. In another example, the thrust coefficient decreases by 50% or more between the first rotational speed and the runaway speed. In another example, the thrust coefficient decreases by 60% or more between the first rotational speed and the runaway speed.

The rotational speed may be defined by way of the tip speed ratio.

Each blade may display a larger chord and/or angle of twist across a major portion of the span of the blade when compared with a blade which is optimised for power coefficient at a prescribed power output.

In one example, the angle of twist is at least 5% greater than that of a corresponding power-coefficient-optimised blade over the length of the blade.

In another example, the angle of twist is at least 10% greater than that of a corresponding power-coefficient-optimised blade over the length of the blade.

In one example, the chord of each blade is at least 10% greater than that of a corresponding power-coefficient-optimised blade over the length of the blade.

In another example, the chord of each blade is at least 20% greater than that of a corresponding power-coefficient-optimised blade over the length of the blade.

In another example, the chord of each blade is at least 40% greater than that of a corresponding power-coefficient-optimised blade over the length of the blade.

In one example, the assembly, or each blade thereof, has a maximum power coefficient of at least 0.35.

In one example, the assembly, or each blade thereof, has a maximum torque coefficient of less than 0.15

In one example, the assembly, or each blade thereof, has a thrust coefficient at the point of maximum power of less than 0.7.

In one example, the assembly, or each blade thereof, has a tip speed ratio at which torque falls to zero at less than twice that tip speed ratio at which maximum power is produced.

According to a second aspect of the present invention there is provided a turbine blade for use in a turbine blade assembly, the blade having a setting angle distribution along the length of the blade such that the thrust coefficient of the blade increases with rotational speed of the turbine assembly up to a first rotational speed and decreases significantly beyond the first rotational speed up to a runaway speed for the turbine assembly.

### BRIEF DESCRIPTION OF THE DRAWINGS

FIGS. 1a and 1b show graphs of blade geometry determined according to the prior art;

FIG. 2 shows a graph of performance coefficients for a blade geometry according to the prior art;

FIGS. 3a and 3b show graphs of an example blade geometry determined according to the present invention;

FIG. 4 shows a graph of performance coefficients for an example blade geometry according to the present invention;

FIG. 5 shows a comparison of geometrical features between a prior art blade and an example blade according to the present invention;

FIG. 6 shows a comparison of twist distribution between a prior art blade and an example blade according to the present invention;

FIG. 7 shows a comparison of thrust coefficient between a prior art blade and an example blade according to the present invention; and,

FIG. 8 shows a comparison of power coefficient between a prior art blade and an example blade according to the present invention;

### DETAILED DESCRIPTION OF THE PREFERRED EMBODIMENTS

As described above, conventional thinking in hydrokinetic turbine blade design is to focus blade design on maximising the power coefficient. This has the disadvantage of producing undesirable off-design performance, especially in terms of thrust behaviour. The present invention derives from an appreciation by the inventor that, by being prepared to relax this focus and accept slightly reduced power coefficient, it is possible to design a blade that has much more benign thrust characteristics. Further research and experimentation around this fundamental shift in thinking, has resulted in the determination of criteria that allow a blade to be produced which can be considered to be ‘passively safe’ since its shape characteristics mitigate or remove the possible dangers caused by excessive thrust loading which occur if the rotor is allowed to accelerate to high tip speed ratios.

The approach proposed by this invention can allow for removal of the pitch system required by the prior art. This can lead to a substantial reduction in unit cost of tidal/wind turbines, improvements in reliability, weight and hence installation cost. The proposed design is inherently safe and could allow the relaxation of requirements on the braking system, bringing further reliability and cost benefits.

However the present invention is not limited to use in fixed pitch or brake-less installations since the properties of the present invention may be used in a variable pitch machine, wherein they may offer a failsafe or backup means for preventing excessive thrust generation by the turbine. Similarly a brake such as a shaft brake may be provided as a generally redundant feature but which may be employed in abnormal circumstances to control rotor speed.

The design process that created the possible families of blades according to the present invention was focused on creating blades that would function within the operational constraints of the turbine system. The objective was to produce blades that would not threaten the integrity of the rest of the system under any conditions and that would reduce the demands on the control system for the need to regulate the speed of the rotor.

Analysis of the criteria which lead to the requirement for conventional control systems and of the operational requirements of a hydrokinetic turbine, such as a tidal turbine, lead to determination of the key constraints which are used to guide the blade form through its intended function. These key constraints are:
Blades produce a maximum power coefficient of at least 0.35 and preferably at least 0.40 (blade efficiency of at least 40%)
Blades produce a maximum torque coefficient of less than 0.15
Blades produce a thrust coefficient at the point of maximum power of less than 0.7
The tip speed ratio at which torque fall to zero does not occur at more than twice that at which maximum power is produced.
The thrust coefficient at runaway (zero torque) represents a significant reduction from that produced at maximum power.

Any of these requirements, either alone or in combination, may be considered to provide a definition of the present invention.

It is the final requirement that may be considered to enable the blades to be described as ‘passively safe’. This feature may be considered to provide for a blade which cannot exceed a threshold maximum thrust generation for a given turbine arrangement regardless of the speed of the blade within the operational limits of the system. Accordingly, the effect of this performance is that the need to prevent the rotor overspeeding by way of additional control means can be removed because, as long as the generator associated with the turbine is specified to cope with generation at higher than normal rotational speeds, the thrust loads produced by the blades will in fact reduce as the rotational speed increases.

In addition, the fourth criterion limits the range of speed through which the generator will be forced to run. Accordingly combination of the fourth and final criteria listed above may be considered to offer a definition of the invention which has practical applicability.

The design process investigated many different geometries and settled on a family of blades that all have performance coefficients which fall within the bounds specified by the criteria listed above.

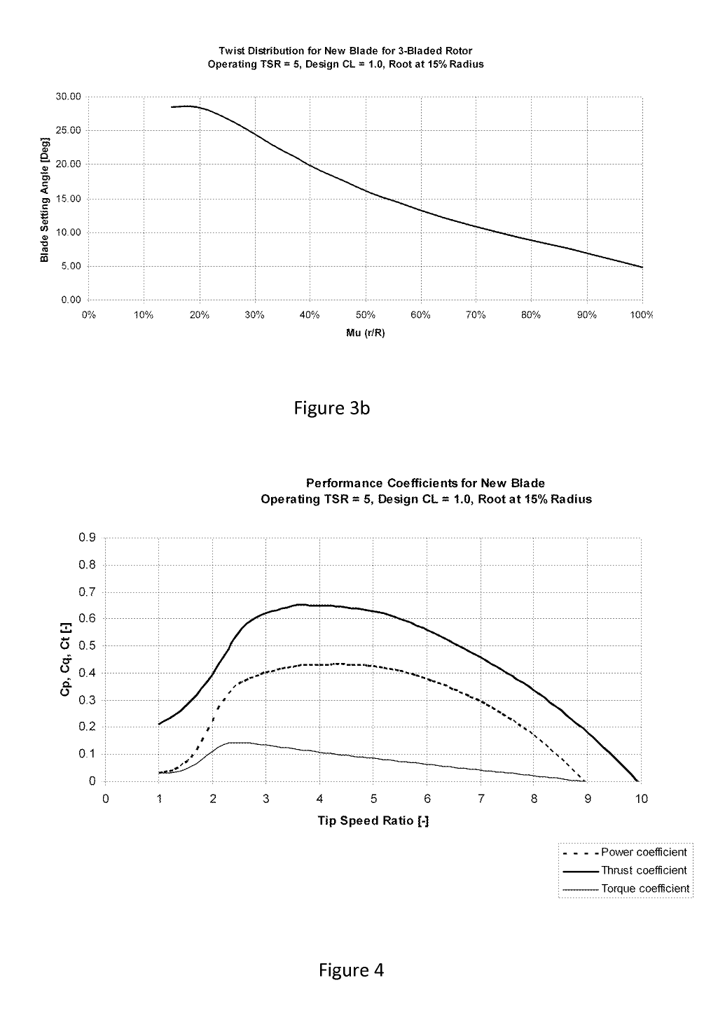

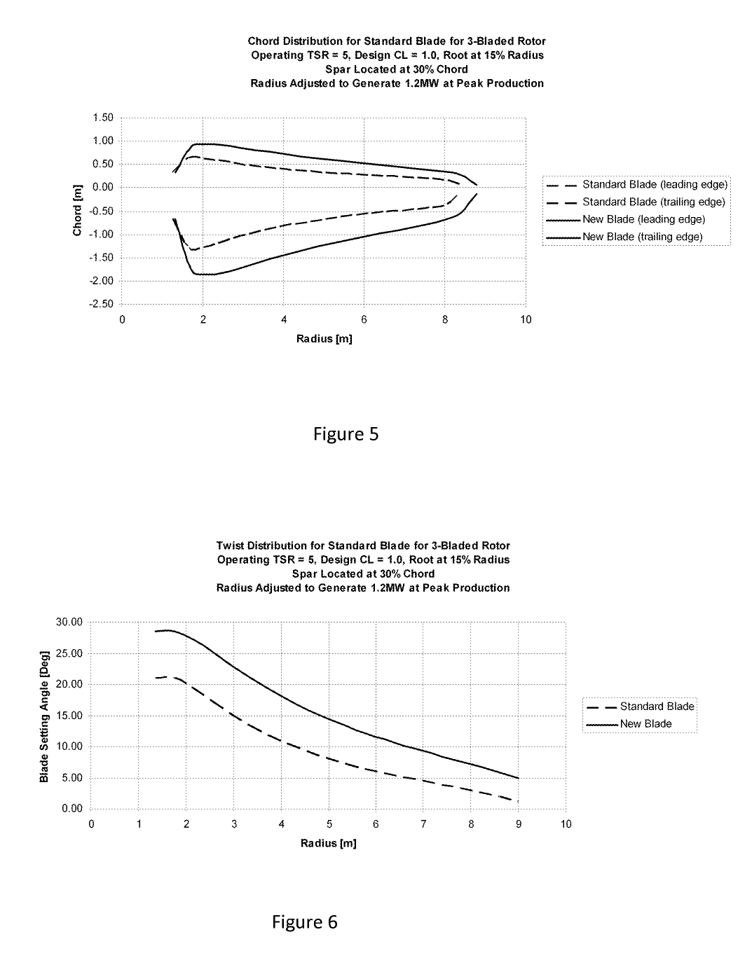

One example geometry according to these criteria is shown in FIGS. 3a and 3b, which provides a plot of chord and twist distributions. A blade designed in this manner and having such geometric characteristics may be considered to provide a passively safe, limited-thrust turbine blade as described above. The angle between the chord and the plane of the rotor angle is defined as the setting angle, and this angle changes along the length of the blade, so as to achieve a setting angle distribution such that the thrust coefficient of the blade increases with rotational speed of the turbine assembly up to a first rotational speed and decreases significantly beyond the first rotational speed up to a runaway speed for the turbine assembly.

Internal structure of the blade is relatively unimportant when it comes to hydrodynamic performance. Thus if a blade was to be produced which has the external geometry within the prescribed envelope prescribed below, it would have the desired performance characteristics, almost regardless of internal structure.

The resulting performance of the above blades is described on the graph below. Performance coefficients were obtained using Garrad-Hassan's ‘Tidal Bladed’ software, which is regarded as an industry-standard simulation tool.

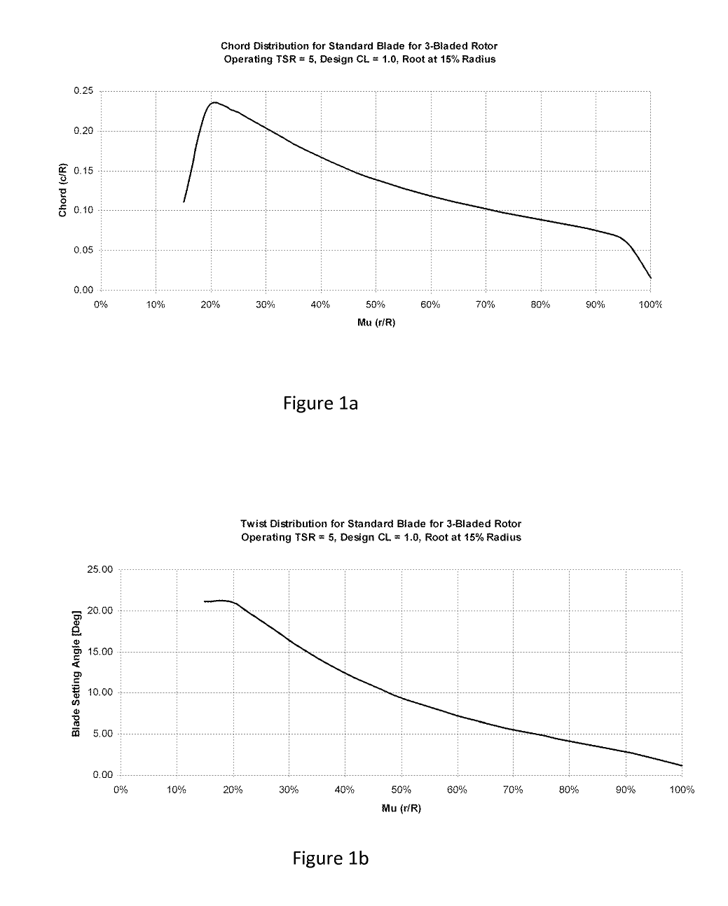

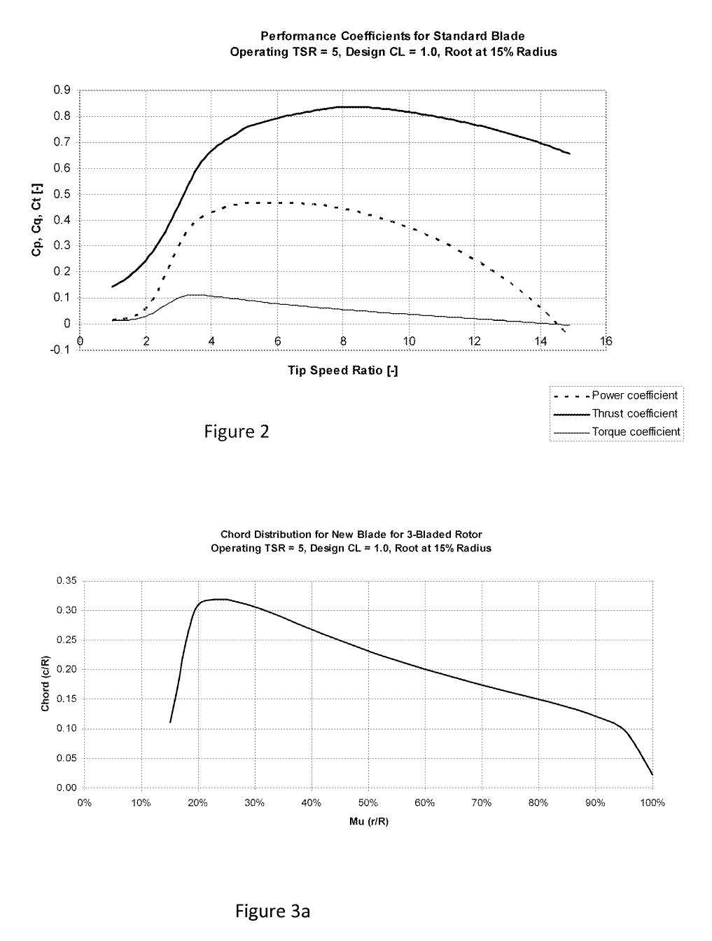

For the purposes of a comparison, the geometry of the new proposed blade is compared to the ‘standard’ blade of FIG. 1. It can be see that the main difference is a noticeably larger chord across the whole span of the blade and a greater degree of twist. To allow meaningful comparison, both blades have had their radii set by a requirement to generate 1.15 MW. This is a sensible value for a machine rated at 1 MW with 13% system losses. It can be seen that there is a small radius increase in the new blade to account for the fact that the power coefficient has dropped slightly. This is a change of approximately 4%.

It should be noted that the novelty in this new design is encompassed primarily in the geometric envelope of the blades. Hydrofoil (or aerofoil) section is far less important to the performance changes and in the examples described herein, the same foil section was used in both of the above blades purely to allow relative comparison of the benefits of the present invention.

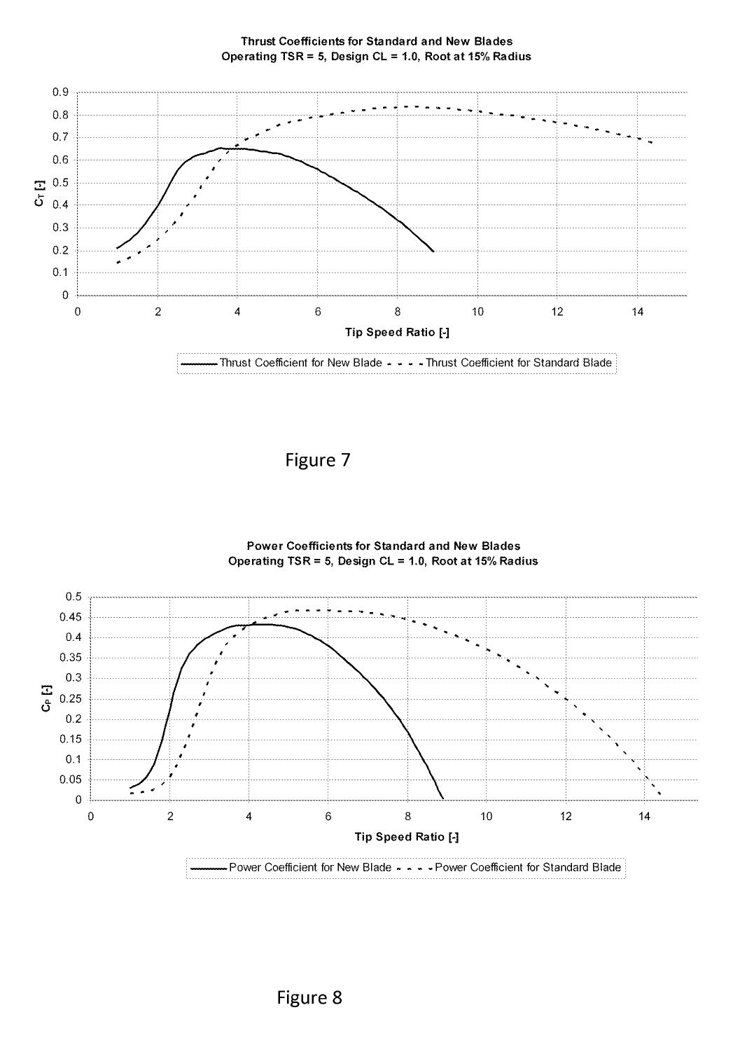

Comparing the thrust characteristics for the two blades, as shown in FIG. 7, the difference is significant. Both curves shown on the figure below stop at the runaway point. The standard blade produces a thrust coefficient of 0.67, whereas the new blade produces only 0.19 at runaway. This is compared to respective peak thrust coefficient values of 0.83 and 0.65.

However comparing the power coefficients and hence the efficiency of the two blades, as shown in FIG. 8, it can be seen that there is a much smaller relative difference in peak power coefficients. Such differences can easily be made up for by the small radius increase seen in the plots above. These two graphs capture arguably the most important benefit of the new blades—they maintain an acceptably high power coefficient (albeit slightly reduced from the power coefficient achievable according to a conventional design methodology) whilst delivering a significant thrust reduction.

The other significant benefit is the large reduction in absolute rotational speed at runaway.

In view of the above, it will be appreciate that the present invention may be defined based upon the departure of the geometric (chord and setting angle) characteristics compared to a blade determined according to the conventional equations on page 1 (above), under given conditions, such as for example a fixed power generation (which may determine necessary radii of turbine blades to be used). Alternatively, any of the other physical or operational differences noted above may give rise to a definition of the invention.

Whilst the present invention has been devised in relation to tidal turbines in particular, it is to be considered applicable to other turbine configurations, including wind turbines, run-of-river turbines or hydro electric turbines with only routine modifications to fit the methodology to such applications. All such systems could potentially benefit from a passive inherently safe approach to controlling turbine speed. Accordingly the present invention is not limited to any one blade profile but rather any number of different blade profiles could be created dependent on the environment operational requirements of the turbine.

1. A power generation turbine assembly comprising a plurality of turbine blades, each blade having a setting angle distribution along the length of the blade such that the thrust coefficient of the blade increases with rotational speed of the turbine assembly up to a first rotational speed and decreases significantly beyond the first rotational speed up to a runaway speed for the turbine assembly.

2. A turbine assembly as claimed in claim 1, wherein the first value of thrust coefficient of the blade at the first rotational speed of the turbine assembly is that at which a maximum power coefficient of the turbine is achieved, and a second value of thrust coefficient at the runaway speed for the turbine assembly is significantly lower than said first value.

3. A turbine assembly as claimed claim 1, wherein the thrust coefficient decreases by 20% or more between the first rotational speed and the runaway speed.

4. A turbine assembly as claimed in claim 1, wherein the thrust coefficient decreases by 50% or more between the first rotational speed and the runaway speed.

5. A turbine assembly as claimed in claim 1, wherein the thrust coefficient decreases by 60% or more between the first rotational speed and the runaway speed.

6. A turbine assembly according to claim 1, wherein the rotational speed is defined by way of the tip speed ratio.

7. A turbine assembly according to claim 1 comprising a fixed-pitch bladed rotor construction.

8. A turbine assembly according to claim 1, wherein the assembly comprises a hydrokinetic turbine assembly.

9. A turbine assembly according to claim 1, wherein each blade displays larger chord and/or angle of twist across a major portion of the span of the blade when compared with a blade which is optimised for power coefficient at a prescribed power output.

10. A turbine assembly as claimed in claim 9, wherein the angle of twist is at least 5% greater than that of a corresponding power-coefficient-optimised blade over the length of the blade.

11. A turbine assembly as claimed in claim 9, wherein the angle of twist is at least 10% greater than that of a corresponding power-coefficient-optimised blade over the length of the blade.

12. A turbine assembly according to claim 9, wherein the chord of each blade is at least 10% greater than that of a corresponding power-coefficient-optimised blade over the length of the blade.

13. A turbine assembly according to claim 9, wherein the chord of each blade is at least 20% greater than that of a corresponding power-coefficient-optimised blade over the length of the blade.

14. A turbine assembly according to claim 9, wherein the chord of each blade is at least 40% greater than that of a corresponding power-coefficient-optimised blade over the length of the blade.

15. A turbine assembly according to claim 1, wherein the assembly or each blade thereof has a maximum power coefficient of at least 0.35.

16. A turbine assembly according to claim 1, wherein the assembly or each blade thereof has a maximum torque coefficient of less than 0.15

17. A turbine assembly according to claim 1, wherein the assembly or each blade thereof has a thrust coefficient at the point of maximum power of less than 0.7.

18. A turbine assembly according to claim 1, wherein the assembly or each blade thereof has a tip speed ratio at which torque falls to zero at less than twice that tip speed ratio at which maximum power is produced.

19. A blade for a turbine assembly as claimed in claim 1.
